(19) United States
(12) Patent Application Publication
(10) Pub. No.: US 2024/0319534 A1
(43) Pub. Date: Sep. 26, 2024

(54) DISPLAY DEVICE

(71) Applicant: Japan Display Inc., Tokyo (JP)

(72) Inventor: Kenichi TAKEMASA, Tokyo (JP)

(21) Appl. No.: 18/735,517

(22) Filed: Jun. 6, 2024

Related U.S. Application Data
(63) Continuation of application No. PCT/JP2022/039157, filed on Oct. 20, 2022.

(30) Foreign Application Priority Data
Dec. 24, 2021 (JP) 2021-210038

(51) Int. Cl. G02F 1/1335; G02F 1/13357; G02F 1/1362; G03B 21/56

(52) U.S. Cl. CPC G02F 1/133553; G02F 1/1336; G02F 1/136209; G03B 21/56

(57) ABSTRACT

A display device includes a video light source unit configured to emit video light, a screen unit having a projection surface on which the video light is projected, a first control circuit configured to control an operation of the video light source unit, and a second control circuit configured to control visible light reflectance of the screen unit. The screen unit includes a plurality of pixels. The second control circuit can selectively change visible light reflectance of each of the plurality of pixels while being synchronized with the first control circuit.

### CROSS REFERENCES TO RELATED APPLICATIONS

The present application is a continuation of International Application No. PCT/JP2022/039157 filed on Oct. 20, 2022 and claims priority to Japanese Patent Application No. 2021-210038 filed on Dec. 24, 2021, the disclosure of which is incorporated herein by reference.

### TECHNICAL FIELD

The present invention relates to a display device.

### BACKGROUND

There is a display device configured to display videos by using a projection device which emits video light and a white screen on which the video light is projected in combination. A projector or the like is known as the projection device. Also, in recent years, techniques for displaying videos on a transparent screen such as HUD (Head Up Display) have been studied. On the other hand, there is a technique of controlling light transmittance by using a liquid crystal panel having a plurality of pixels. Patent Document 1 (Japanese Unexamined Patent Application Publication No. 2021-026222) describes a light dimming sheet using a liquid crystal panel.

### SUMMARY

In a case of a display device configured to project video light onto a screen, there is a room for improvement in terms of improving image quality. For example, in the case of a display device such as an HUD configured to irradiate a transparent screen with video light, there is a demand for increasing the visible light transmittance of the screen. However, if the visible light transmittance of the screen is simply increased, reflectance of the video light decreases, so that it becomes difficult for an observer to visually recognize the video light. Conversely, if the visible light reflectance of the screen is increased, visible light transmittance of the screen decreases, so that the visibility of the background behind the screen decreases.

Further, for example, in the case of a display device configured to project video light emitted from a projector onto a white screen, the contrast decreases due to, for example, black floating caused by stray light in some cases.

An object of the present invention is to provide a technique for improving the performance of a display device configured to project video light onto a screen.

A display device according to an embodiment includes a video light source unit configured to emit video light, a screen unit having a projection surface on which the video light is projected, a first control circuit configured to control an operation of the video light source unit, and a second control circuit configured to control visible light reflectance of the screen unit. The screen unit includes a plurality of pixels. The second control circuit can selectively change visible light reflectance of each of the plurality of pixels while being synchronized with the first control circuit.

### BRIEF DESCRIPTION OF DRAWINGS

FIG. 1 is an explanatory diagram showing a configuration example of a display device according to an embodiment;

FIG. 2 is an explanatory diagram schematically showing a state in which an observer visually recognizes a virtual image of a video from a video light source unit and a background superimposed on each other in a configuration example of an HUD to which the display device shown in FIG. 1 is applied;

FIG. 3 is an explanatory diagram showing an example of the virtual image shown in FIG. 2;

FIG. 4 is a plan view showing an example of a structure of a screen unit shown in FIG. 1;

FIG. 5 is a cross-sectional view taken along an A-A line in FIG. 4;

FIG. 6 is a transparent plan view showing a positional relationship of a plurality of pixels shown in FIG. 4, a plurality of pixel electrodes, and a common electrode shown in FIG. 5;

FIG. 7 is an explanatory diagram showing an example of video light supplied from the video light source unit and a projection surface of the screen unit shown in FIG. 1;

FIG. 8 is an explanatory diagram showing an example in which the observer shown in FIG. 2 visually recognizes the screen unit of the display device shown in FIG. 7;

FIG. 9 is an explanatory diagram showing a modification with respect to FIG. 7;

FIG. 10 is an explanatory diagram showing an example in which the observer shown in FIG. 2 visually recognizes the screen unit of the display device shown in FIG. 9;

FIG. 11 is an explanatory diagram schematically showing a state in which an observer visually recognizes a video from a video light source unit in a configuration example of a display device using a projector which is a modification with respect to FIG. 2; and

FIG. 12 is an enlarged cross-sectional view of a screen unit shown in FIG. 11 as a modification with respect to FIG. 5.

### DETAILED DESCRIPTION OF THE INVENTION

Hereinafter, each embodiment of the present invention will be described with reference to drawings. Note that the disclosure is merely an example, and it is a matter of course that any alteration that a person skilled in the art easily conceives of while keeping a gist of the present invention is included in the range of the present invention. In addition, the drawings schematically illustrate a width, a thickness, a shape, and the like of each portion as compared with actual aspects in order to make the description clearer, but the drawings are merely examples and do not limit the interpretation of the present invention. Further, the same elements as those described in relation to the foregoing drawings are denoted by the same or related reference characters in this specification and the respective drawings, and detailed descriptions thereof will be omitted as appropriate.

In the following embodiment, an example in which a display device including a video light source unit configured to emit video light and a screen unit having a projection surface on which the video light is projected is applied to an HUD will be described first, and an example in which the display device is applied to a projector will be then described as a modification.

In the following description, when expression of “in plan view” is used, it means a plan view when a projection surface is viewed except for the case where it is used in a particularly different meaning. Also, when expression of “A and B are superimposed” or the like is used in plan view, it includes a case in which A and B are superimposed in a transparent plan view seen through a projection surface.

### <Display Device>

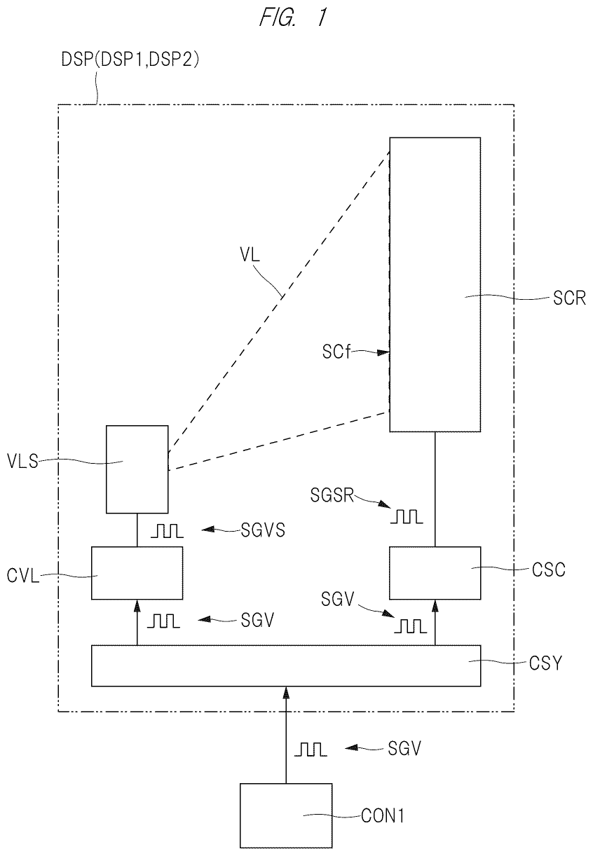

First, a configuration example of a display device according to the present embodiment will be described. FIG. 1 is an explanatory diagram showing a configuration example of the display device according to the embodiment. Note that the configuration example related to a display device DSP shown in FIG. 1 is common to each of a display device DSP1 configured of an HUD described below and a display device DSP2 configured of a set of a projector and a screen described later as a modification.

As shown in FIG. 1, the display device DSP according to the present embodiment includes a video light source unit VLS configured to emit video light VL, a screen unit SCR having a projection surface SCf on which the video light VL is projected, a control circuit CVL configured to control an operation of the video light source unit VLS, and a control circuit CSC configured to control visible light reflectance of the screen unit SCR. The control circuit CVL can control the timing of the operation of the video light source unit VLS to emit the video light VL and the pixel selection operation.

The operation of the control circuit CVL and the operation of the control circuit CSC can be synchronized with each other. In the example shown in FIG. 1, the display device DSP includes a synchronization circuit CSY configured to synchronize the operation of the control circuit CVL and the operation of the control circuit CSC. A video signal SGV output from a video signal source CON1 such as a computer is input to the synchronization circuit CSY of the display device DSP. The synchronization circuit CSY outputs video signals SGV at timing synchronized with each of the control circuit CVL and the control circuit CSC. The control circuit CVL generates a control signal SGVS for controlling the video light source unit VLS based on the video signal SGV, and outputs the control signal SGVS to the video light source unit VLS. The control circuit CSC generates a control signal SGSR for controlling the screen unit SCR based on the video signal SGV, and outputs the control signal SGSR to the screen unit SCR. With the configuration shown in FIG. 1, the video light source unit VLS and the screen unit SCR can be operated at mutually synchronized timing.

As a modification with respect to FIG. 1, it is possible to omit the synchronization circuit CSY. In this case, the video signal SGV is supplied from the video signal source CON1 to each of the control circuit CVL and the control circuit CSC.

Although the details will be described later, in the case of the display device DSP shown in FIG. 1, the screen unit SCR includes a plurality of pixels on the projection surface SCf in plan view. In addition, the control circuit CSC can selectively change the visible light reflectance of each of the plurality of pixels while being synchronized with the control circuit CVL. Effects obtained by this configuration will be described later.

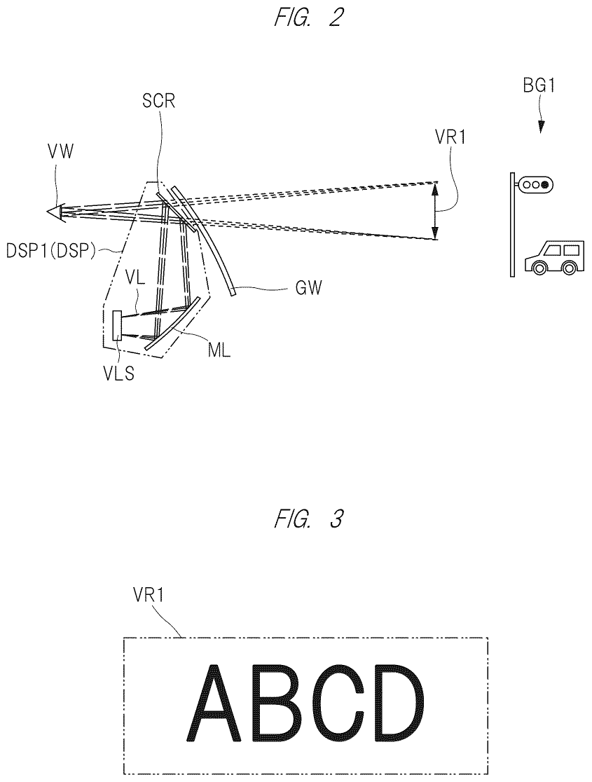

FIG. 2 is an explanatory diagram schematically showing a state in which an observer visually recognizes a virtual image of a video from a video light source unit and a background superimposed on each other in a configuration example of an HUD to which the display device shown in FIG. 1 is applied. FIG. 3 is an explanatory diagram showing an example of the virtual image shown in FIG. 2. The example shown in FIG. 2 schematically shows the state in which an observer VW visually recognizes a background BG1 and a virtual image VR1 superimposed on each other visible through a front window GW by using the display device DSP1 which is, for example, an HUD mounted in an automobile. Note that, in the example shown in FIG. 2, the video light VL is projected onto the screen unit SCR via a mirror unit ML. However, it is also possible to directly project the video light VL from the video light source unit VLS onto the screen unit SCR as shown in FIG. 1 by omitting the mirror portion ML.

As shown in FIG. 2, in the case of the display device DSP1 which is an HUD, the observer VW can visually recognize a video in which the virtual image VR1 of the video projected on the screen unit SCR of the display device DSP1 and the background BG1 are superimposed. The virtual image VR1 includes character information as illustrated in FIG. 3, for example.

When the observer VW visually recognizes the background BG1 through the screen unit SCR as in the HUD, it is preferable that the screen unit SCR has high visible light transmissivity from the standpoint of improving the visibility of the background BG1. On the other hand, from the standpoint of improving the visibility of the virtual image VR1, it is preferable to improve the visible light reflectivity of the screen unit SCR. Thus, the screen unit SCR used as a half mirror is required to have both the visible light transmissivity and the visible light reflectivity, which are in a trade-off relationship.

In the display device DSP1 according to the present embodiment, as described above, the control circuit CSC can selectively change the visible light reflectance of each of the plurality of pixels while being synchronized with the control circuit CVL. In this case, on the projection surface SCf (see FIG. 1) of the screen unit SCR, it is possible to selectively increase the visible light reflectance of the pixels on which the video required to be visually recognized by the observer VW is projected. For example, in the case of displaying character information as in the virtual image VR1 shown in FIG. 3, the reflectance of the pixels on which the characters are projected is selectively increased and the state of high visible light transmittance is maintained in the pixels around the pixels on which the characters are projected. In this case, the visibility of the character information can be improved because of the high reflectance of the pixels on which the characters are projected. In addition, since the background BG1 shown in FIG. 1 can be visually recognized through the pixels on which characters are not projected, the visibility of the background BG1 can also be improved.

As described above, with the display device DSP1 according to the present embodiment, it is possible to improve each of the visibility of the video projected from the video light source unit VLS shown in FIG. 1 and the visibility of the background BG1 visually recognized through the screen unit SCR.

### <Screen Unit>

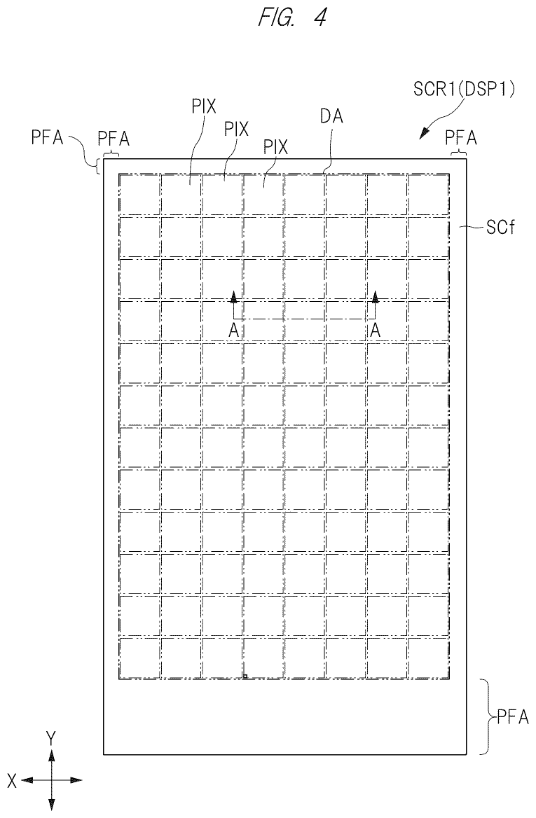

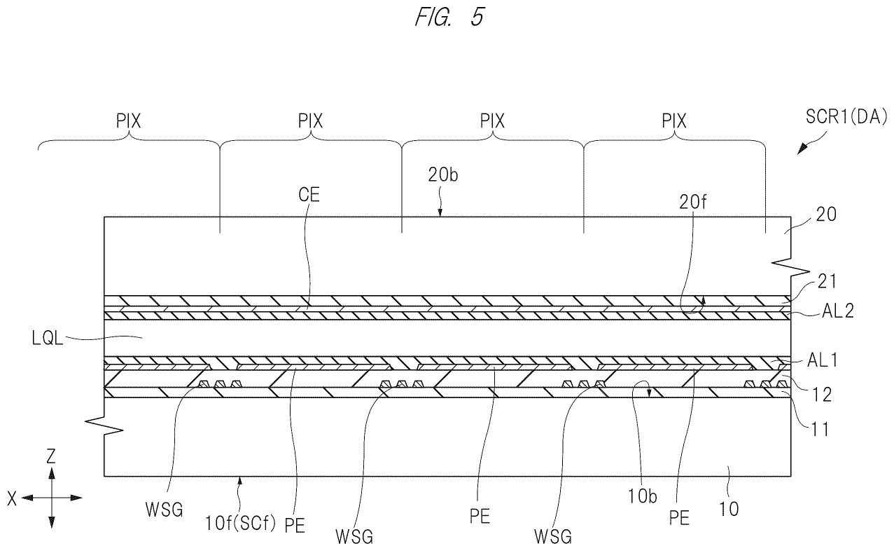

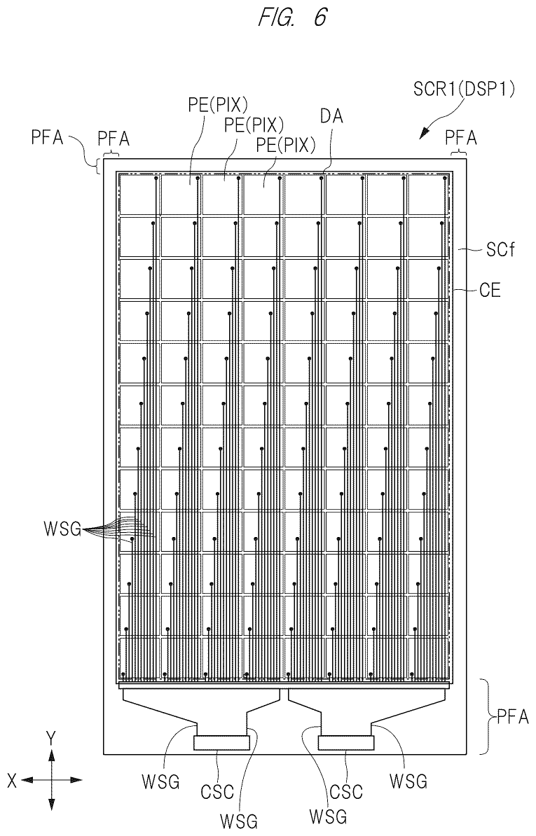

Next, a configuration example of the screen unit SCR capable of selectively changing the visible light reflectance of each of the plurality of pixels will be described. FIG. 4 is a plan view showing an example of a structure of the screen unit shown in FIG. 1. FIG. 5 is a cross-sectional view taken along an A-A line in FIG. 4. FIG. 6 is a transparent plan view showing a positional relationship of a plurality of pixels shown in FIG. 4, a plurality of pixel electrodes, and a common electrode shown in FIG. 5.

As shown in FIG. 4, the screen unit SCR1 of the display device DSP1 includes a plurality of pixels PIX arranged in a matrix in plan view showing the projection surface SCf. In the example shown in FIG. 4, 96 pixels PIX arranged in 8 columns in the X direction and 12 rows in the Y direction are illustrated, but the number of the pixels PIX is not limited to that shown in FIG. 4, and may be 95 or less or 97 or more.

Further, in the example shown in FIG. 4, the screen unit SCR1 of the display device DSP1 includes a display region DA and a peripheral region PFA surrounding the display region DA. The display region DA is a planned region on which the video light VL (see FIG. 1) is to be projected, and the display region DA is divided into the plurality of pixels PIX. The peripheral region PFA is a region where the projection of the video light VL is not planned. A part of the circuit for driving the screen unit SCR1 is arranged in the peripheral region PFA.

From the standpoint of improving the quality of the video visually recognized by the observer VW shown in FIG. 2, it is preferable that the area of the peripheral region PFA is as small as possible. For example, as a modification with respect to FIG. 4, a configuration in which the peripheral region PFA is provided on only one of the four sides of the quadrilateral screen unit SCR1 also conceivable. Alternatively, even when the peripheral region PFA is provided along each of the four sides of the screen unit SCR1, the quality of the video visually recognized by the observer VW can be improved if the visible light transmittance in the peripheral region PFA is as high as that of the display region DA.

As shown in FIG. 5, the screen unit SCR1 includes a substrate 10, a substrate 20 arranged at a position facing the substrate 10, a liquid crystal layer LOL sealed between the substrate 10 and the substrate 20, a plurality of pixel electrodes PE arranged between the substrate 10 and the substrate 20, and a common electrode CE arranged between the substrate 10 and the substrate 20.

Also, as shown in FIG. 6, the plurality of pixel electrodes PE and the plurality of pixels PIX are arranged at positions that overlap each other. On the other hand, the common electrode CE is arranged across the plurality of pixels PIX.

The liquid crystal molecules contained in the liquid crystal layer LOL shown in FIG. 5 are optical elements that have the property of changing the orientation direction by applying an electric field. When a potential is applied to the pixel electrode PE in a state where a common potential is supplied to the common electrode CE, a potential difference is generated between the pixel electrode PE and the common electrode CE. The screen unit SCR1 can change the orientation direction of the liquid crystal molecules by using the electric field generated by this potential difference. The reflectance of light is changed in the pixel PIX in which the orientation direction of the liquid crystal molecules is changed.

In the case of the present embodiment, in the pixel in which an electric field is generated between the pixel electrode PE and the common electrode CE, for example, the transmittance of visible light from the substrate 10 arranged on the side of the projection surface to the substrate 20 is reduced, and the reflectance of visible light entering from the substrate 10 and reflected in the direction toward the substrate 10 is increased. In other words, the light entering the substrate 10 is less likely to reach the substrate 20 and more likely to be reflected toward the substrate 10. From the viewpoint of the observer VW shown in FIG. 2, the pixel in which an electric field is generated between the pixel electrode PE and the common electrode CE is visually recognized as being whitened as compared with the pixel in which no electric field is generated.

By the way, as a driving method for selectively generating an electric field in the plurality of pixels PIX, there is a method in which a plurality of first electrodes extending in the X direction and a plurality of second electrodes extending in the Y direction are crossed. In this method, the intersections where the plurality of first electrodes and the plurality of second electrodes are crossed are regarded as pixels. By synchronizing the timing between the signal current flowing through the first electrode and the signal current flowing through the second electrode in this state, the electric field can be generated in the specific pixel. The driving method like this is referred to as the passive matrix method. The passive matrix method is effective when a plurality of pixels arranged regularly are turned on at the same time or when the number of pixels arranged in the display region DA is small. However, control becomes difficult when the number of pixels is increased in order to improve the resolution.

In the case of the present embodiment, the control circuit CSC shown in FIG. 1 can individually output the control signal SGSR (see FIG. 1) to each of the plurality of pixel electrodes PE shown in FIG. 6. More specifically, as shown in FIG. 6, the pixel electrodes PE are arranged so as to correspond to each of the plurality of pixels PIX. Also, signal wirings WSG independent of each other are connected to each of the plurality of pixel electrodes PE. The control circuit CSC is connected to each of the plurality of signal wirings WSG. In this case, the control circuit CSC can individually transmit the control signal SGSR to each of the plurality of pixel electrodes PE via the signal wiring WSG. As a result, the screen unit SCR1 can individually change the visible light reflectance for each of the plurality of pixels PIX.

Further, as a modification with respect to the present embodiment, there is a method of arranging switching elements (active elements) so as to correspond to each of the plurality of pixels PIX. For example, a thin film transistor (TFT) can be used as the switching element. In this method, a plurality of scanning signal lines extending in the X direction and a plurality of control signal lines extending in the Y direction are provided, and one scanning signal line and one control signal line are connected to each of the plurality of switching elements. ON or OFF of the switching element is selected by the scanning signal flowing through the scanning signal line, and the control signal is transmitted to the control signal line in synchronization with the scanning signal. In this way, a specific pixel among the plurality of pixels PIX can be selectively turned on. The driving method like this is referred to as the active matrix method.

In the case of the active matrix method, it is possible to cope with the increase in the number of pixels as compared with the passive matrix method. However, the method in which the plurality of pixel electrodes PE are arranged so as to correspond to the plurality of pixels and the control signal SGSR is individually output to each of the plurality of pixel electrodes PE as shown in FIG. 6 is more preferable in terms of simplifying the structure. Further, since the number of wirings arranged in the peripheral region PFA can be reduced by simplifying the structure required for driving, it is preferable from the standpoint of improving the visible light transmittance of the peripheral region PFA or reducing the area of the peripheral region PFA.

In the example shown in FIG. 5, the substrate 10 has a front surface 10f and a back surface 10b on a side opposite to the front surface 10f. The projection surface SCf of the screen unit SCR1 is present on the front surface 10f. Each of the plurality of pixel electrodes PE is formed on the back surface 10b. More specifically, an insulating layer 11, an insulating layer 12, and an alignment film ALL are stacked on the back surface 10b of the substrate 10. Each of the plurality of signal wirings WSG is formed on the insulating layer 11 and is covered with the insulating layer 12. Each of the plurality of pixel electrodes PE is formed on the insulating layer 12 and is covered with the alignment film AL1. Note that, as a modification with respect to FIG. 5, the plurality of pixel electrodes PE may be formed on a front surface 20f of the substrate 20 and the common electrode CE may be formed on the back surface 10b of the substrate 10.

Also, in the example shown in FIG. 5, the substrate 20 has a front surface 20f and a back surface 20b on a side opposite to the front surface 20f. The common electrode CE is arranged on the front surface 20f of the substrate 20. More specifically, an insulating layer 21, the common electrode CE, and an alignment film AL2 are stacked on the front surface 20f of the substrate 20. The common electrode CE is formed on the insulating layer 21 and is covered with the alignment film AL2. The liquid crystal layer LOL is sealed between the alignment film AL1 and the alignment film AL2. The plurality of pixel electrodes PE and the common electrode CE are arranged to face each other with the liquid crystal layer LOL interposed therebetween. However, as another modification with respect to FIG. 5, the plurality of pixel electrodes PE and the common electrode CE may be arranged on the back surface 10b of the substrate 10 or on the front surface 20f of the substrate 20. This modification includes a method of arranging and forming the plurality of pixel electrodes PE and the common electrode CE in the same layer (for example, on the insulating layer 12 shown in FIG. 5). Further, the above modification includes a method of sequentially stacking a layer in which the common electrode CE is formed and a layer in which the plurality of pixel electrodes PE are formed on the substrate 10.

In a case where the common electrode CE and the pixel electrode PE are arranged to face each other with the liquid crystal layer LOL interposed therebetween, the liquid crystal molecules of the liquid crystal layer LOL are driven by a so-called vertical electric field mode such as the TN (Twisted Nematic) method or the VA (Vertical Alignment) method. On the other hand, in a case where the common electrode CE and the pixel electrode PE are stacked on the same substrate, the liquid crystal molecules of the liquid crystal layer LOL are driven by a so-called horizontal electric field mode such as the IPS (In Plane Switching) method or the FFS (Fringe Field Switching) method.

Each of the pixel electrode PE and the common electrode CE is preferably made of a transparent conductor material such as ITO (Indium Tin Oxide) from the standpoint of improving the visible light transmissivity of the screen unit SCR1.

### <Example of Control Method>

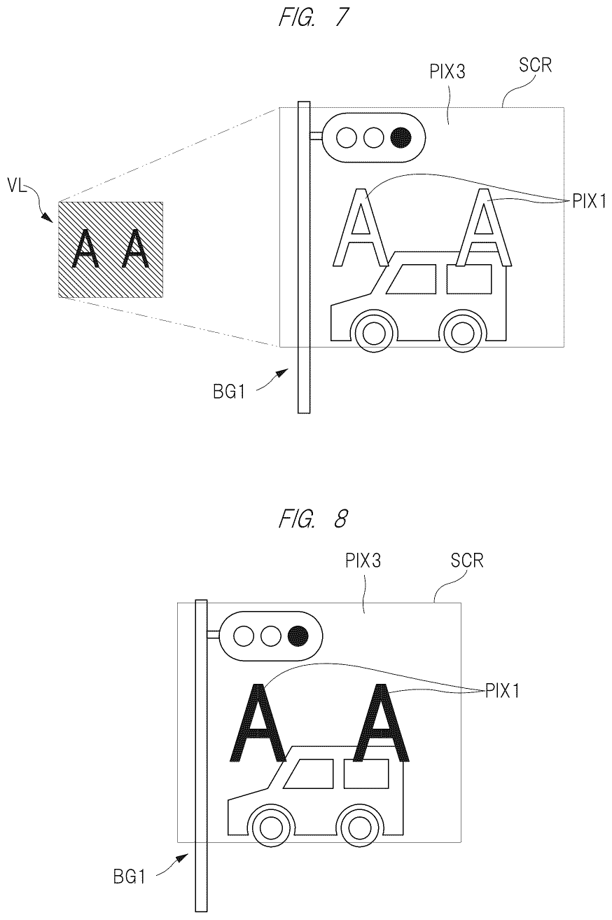

Next, a method of controlling video display by the display device according to the present embodiment will be described. FIG. 7 is an explanatory diagram showing an example of video light supplied from the video light source unit and a projection surface of the screen unit shown in FIG. 1. FIG. 8 is an explanatory diagram showing an example in which the observer shown in FIG. 2 visually recognizes the screen unit of the display device shown in FIG. 7.

As shown in FIG. 7, when character information is projected as the video light VL, the background around the character information does not need to be projected in some cases. In this case, as shown in FIG. 7, the video light VL includes a first color (for example, transparent or black) as a background color of the character information and a second color as a color for the character information. The second color may be any one color other than the first color, or may be a plurality of colors other than the first color.

In the case of the example shown in FIG. 7, the control circuit CSC configured to control the screen unit SCR controls the plurality of pixels PIX (see FIG. 4) of the screen unit SCR such that the visible light reflectance of the pixels PIX1 on which the video light VL other than the first color is projected is higher than the visible light reflectance of the pixels PIX3 on which the video light VL of the first color is projected. In this case, as illustrated in FIG. 7, the observer VW (see FIG. 2) visually recognizes the pixels PIX1 with higher visible light reflectance as being more whitened than the other pixels PIX3. On the other hand, since the pixels PIX3 with relatively low visible light reflectance have high visible light transmittance, the observer VW can visually recognize the background BG1 through the screen unit SCR.

When the video light VL is projected onto the screen unit SCR in this state, the character information is projected onto the whitened pixels PIX1 as shown in FIG. 8, and it is thus possible to improve the visibility of the character information. Also, the video light VL other than the character information is emitted to the outside through the pixels PIX3 with high visible light transmittance. As a result, the background BG1 and the character information can be visually recognized clearly.

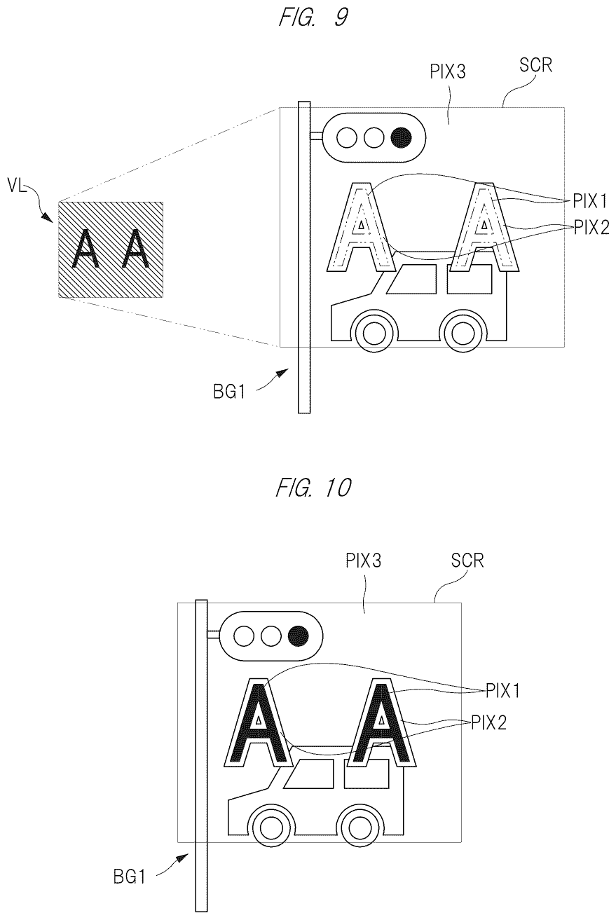

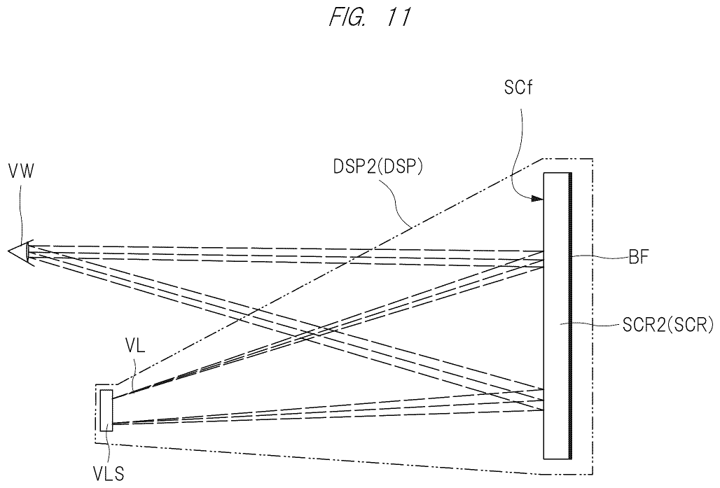

Further, as a modification with respect to the control method shown in FIG. 7 and FIG. 8, the control method shown in FIG. 9 and FIG. 10 can be applied. FIG. 9 is an explanatory diagram showing a modification with respect to FIG. 7. FIG. 10 is an explanatory diagram showing an example in which the observer shown in FIG. 2 visually recognizes the screen unit of the display device shown in FIG. 9.

In the case of the example shown in FIG. 9, the control circuit CSC configured to control the screen unit SCR controls the plurality of pixels PIX (see FIG. 4) of the screen unit SCR such that the visible light reflectance of the pixels PIX1 on which the video light VL other than the first color is projected and the pixels PIX2 arranged around the pixels PIX1 is higher than the visible light reflectance of the pixels PIX3 on which the video light VL of the first color is projected and which are arranged at positions different from the pixels PIX1 and the pixels PIX2. In this case, as illustrated in FIG. 9, the observer VW (see FIG. 2) visually recognizes the pixels PIX1 with higher visible light reflectance as being more whitened than the other pixels PIX3. On the other hand, since the pixels PIX3 with relatively low visible light reflectance have high visible light transmittance, the observer VW can visually recognize the background BG1 through the screen unit SCR.

When the video light VL is projected onto the screen unit SCR in this state, the character information is projected onto the whitened pixels PIX1 and the pixels PIX2 whitened similarly are arranged around the character information as shown in FIG. 10, and it is thus possible to further improve the visibility of the character information. Also, the video light VL other than the character information is emitted to the outside through the pixels PIX3 with high visible light transmittance. As a result, the background BG1 and the character information can be visually recognized clearly. This modification can achieve an effect of increasing the margin for the case where the positional accuracy of the projected character information is lowered.

In the case of the present embodiment, it is important to align the pixels for the video projected on the screen unit SCR with the pixels whose visible light reflectance is to be controlled in the screen unit SCR. For this alignment, it is preferable to perform calibration for alignment as the preparation for starting video display. Examples of calibration methods include the following method. That is, in a state where all the pixels of the screen unit SCR are controlled to be whitened, a video pattern for alignment is projected onto the screen unit SCR. Thereafter, the video pattern for alignment projected on the screen unit SCR is imaged by an image scanner (not shown), and misalignment is checked by comparing the position of the pixels of the screen unit SCR and the position of the projected video pattern.

Note that FIG. 7 to FIG. 10 show the character information as an example of the video projected on the screen unit SCR, but the type of video is not limited to character information. For example, the present invention can be applied to various videos such as graphic information, character designs, and photographs.

### <Modification of Projector>

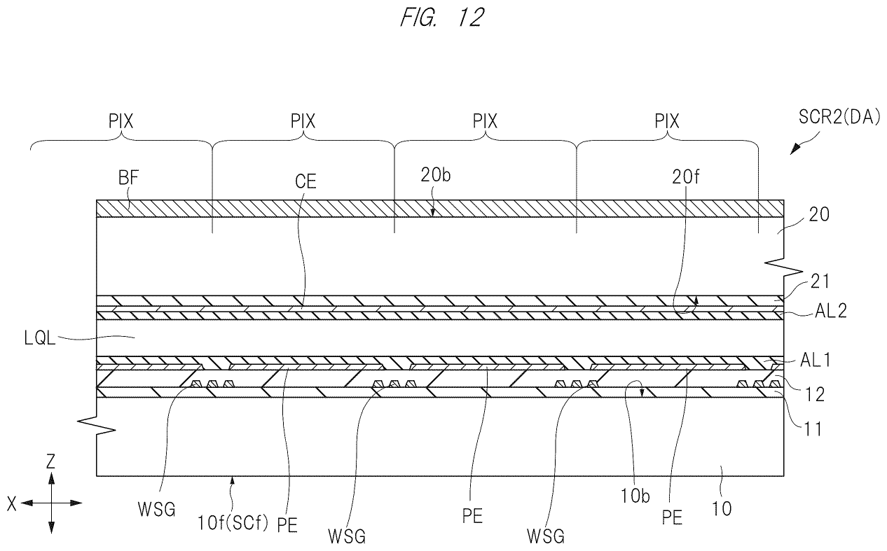

Next, a modification in which a projector is used as the video light source unit VLS shown in FIG. 1 will be described. FIG. 11 is an explanatory diagram schematically showing a state in which an observer visually recognizes a video from a video light source unit in a configuration example of a display device using a projector which is a modification with respect to FIG. 2. FIG. 12 is an enlarged cross-sectional view of a screen unit shown in FIG. 11 as a modification with respect to FIG. 5.

A display device DSP2 shown in FIG. 11 differs from the display device DSP1 shown in FIG. 2 in that the observer VW does not have to visually recognize a background image of a screen unit SCR2. The video light source unit VLS of the display device DSP1 is a projection device referred to as a so-called projector. Generally, when a projector is used, the projection surface SCf of the screen unit SCR is often white in order to efficiently reflect the video light VL. However, in the case of a display device configured to project video light emitted from a projector onto a white screen, the contrast decreases due to, for example, black floating caused by light leakage or stray light in some cases. More specifically, since a region where black is desired to be displayed is visually recognized as a color tone close to gray due to black floating, the contrast with the white portion decreases.

According to the study by the inventor of this application, it has been found that black floating can be suppressed by applying the technique of the display device DSP1 described with reference to FIG. 2 to FIG. 10 to the screen unit SCR shown in FIG. 11.

As shown in FIG. 12, the substrate 20 has the front surface 20f and the back surface 20b on a side opposite to the front surface 20f. A light shielding film BF is formed on the back surface 20b. The light shielding film BF is a black film. As an example of the case where the light shielding film BF is made of an inorganic material, a metal oxide film that is visually recognized as black can be presented. Alternatively, as an example of the case where the light shielding film BF contains an organic material, a resin film containing a black pigment can be presented. The light shielding film BF is a low reflectance film having optical properties of absorbing or scattering the incident light. Note that the structure of the screen unit SCR2 of the display device DSP2 is divided into the plurality of pixels PIX like the screen unit SCR1 shown in FIG. 4 and FIG. 6. Further, since the structures of the pixel electrode PE and the common electrode CE are also the same as those of the screen unit SCR1, redundant descriptions will be omitted.

In the case of this modification, the visible light reflectance of the screen unit SCR2 is controlled by the method similar to the control method described with reference to FIG. 7 and FIG. 8. As shown in FIG. 7, the video light VL includes black light (first color) and non-black light (second color). The second color may be any one color other than black or may be a plurality of colors other than black.

By replacing the first color with black in the description with reference to FIG. 7 and FIG. 8, the description can be given as follows. That is, the control circuit CSC configured to control the screen unit SCR controls the plurality of pixels PIX (see FIG. 4) of the screen unit SCR such that the visible light reflectance of the pixels PIX1 on which the non-black video light VL is projected is higher than the visible light reflectance of the pixels PIX3 on which the black video light VL is projected. In this case, as illustrated in FIG. 7, the observer VW (see FIG. 2) visually recognizes the pixels PIX1 with higher visible light reflectance as being more whitened than the other pixels PIX3. On the other hand, since the pixels PIX3 with relatively low visible light reflectance have high visible light transmittance, the observer VW can visually recognize the black of the light shielding film BF formed on the back surface 20b of the substrate 20 through the screen unit SCR.

When the video light VL is projected onto the screen unit SCR in this state, the light other than black is projected onto the whitened pixels PIX1. Further, in the pixels PIX3 that should display black, even if light leaks from surrounding pixels, it is transmitted through the pixel PIX3 with high visible light transmittance and is absorbed or scattered by the light shielding film BF shown in FIG. 12. As a result, in the video projected on the projection surface SCf of the screen unit SCR2 shown in FIG. 12, black floating is reduced and the contrast is improved.

Although the embodiment and typical modifications have been described above, the above-described technique can be applied to various modifications other than the illustrated modifications. For example, the above-described modifications may be combined with each other.

A person having ordinary skill in the art can conceive of various alterations and corrections within a range of the idea of the present invention, and it is interpreted that the alterations and corrections also belong to the scope of the present invention. For example, the embodiment obtained by performing addition or elimination of components or design change or the embodiment obtained by performing addition or reduction of process or condition change to the embodiment described above by a person having an ordinary skill in the art is also included in the scope of the present invention as long as it includes the gist of the present invention.

The present invention can be applied to display devices and electronic devices incorporating display devices.

What is claimed is:

1. A display device comprising:
a video light source unit configured to emit video light;
a screen unit having a projection surface on which the video light is projected;
a first control circuit configured to control an operation of the video light source unit; and
a second control circuit configured to control visible light reflectance of the screen unit,
wherein the screen unit includes a plurality of pixels, and
wherein the second control circuit can selectively change visible light reflectance of each of the plurality of pixels while being synchronized with the first control circuit.

2. The display device according to claim 1,
wherein the same video signal is input to each of the first control circuit and the second control circuit, and
wherein the second control circuit controls the visible light reflectance of each of the plurality of pixels based on the video signal.

3. The display device according to claim 2,
wherein the video light includes a first color and a color other than the first color, and
wherein the second control circuit controls the plurality of pixels such that visible light reflectance of pixels on which light of the color other than the first color is projected is higher than visible light reflectance of pixels on which light of the first color is projected.

4. The display device according to claim 2,
wherein the video light includes a first color and a color other than the first color, and
wherein the second control circuit controls the plurality of pixels such that visible light reflectance of each of first pixels on which light of the color other than the first color is projected and second pixels arranged around the first pixels is higher than visible light reflectance of third pixels on which light of the first color is projected and which are arranged at positions different from the first pixels and the second pixels.

5. The display device according to claim 1,
wherein the screen unit includes:
a first substrate;
a second substrate arranged at a position facing the first substrate;
a liquid crystal layer sealed between the first substrate and the second substrate;
a plurality of first electrodes arranged between the first substrate and the second substrate; and
a second electrode arranged between the first substrate and the second substrate,
wherein the plurality of first electrodes and the plurality of pixels are arranged at positions that overlap each other in plan view,
wherein the second electrode is arranged across the plurality of pixels in plan view, and
wherein the second control circuit individually outputs a control signal to each of the plurality of first electrodes.

6. The display device according to claim 5,
wherein the first substrate has a first front surface and a first back surface on a side opposite to the first front surface,
wherein the projection surface of the screen unit is present on the first front surface, and
wherein each of the plurality of first electrodes is formed on the first back surface.

7. The display device according to claim 6,
wherein the second substrate has a second front surface and a second back surface on a side opposite to the second front surface,
wherein the second electrode is arranged on the second front surface of the second substrate, and
wherein the plurality of first electrodes and the second electrode are arranged to face each other with the liquid crystal layer interposed therebetween.

8. The display device according to claim 6,
wherein the second substrate has a second front surface and a second back surface on a side opposite to the second front surface, and
wherein a light shielding film is formed on the second back surface.
